(19) United States
(12) Patent Application Publication
(10) Pub. No.: US 2026/0184390 A1
(43) Pub. Date: Jul. 2, 2026

(54) FLOW SEPARATION SUPPRESSION DEVICE

(71) Applicants: TOHOKU UNIVERSITY, Sendai-shi (JP); TOYODA GOSEI CO., LTD., Kiyosu-shi (JP)

(72) Inventors: Aiko YAKENO, Sendai-shi (JP); Shunsuke AOYAMA, Kiyosu-shi (JP); Yasuhiro KANEMOTO, Kiyosu-shi (JP)

(21) Appl. No.: 19/405,791

(22) Filed: Dec. 2, 2025

(30) Foreign Application Priority Data
Dec. 26, 2024 (JP) 2024-229827

(51) Int. Cl. B62D 35/00

(52) U.S. Cl. CPC B62D 35/007

(57) ABSTRACT

A flow separation suppression device is provided on an outer surface of a moving body and includes a flow separation suppressing portion. The flow separation suppressing portion includes two ridges and a recessed groove. The ridges are spaced apart from each other in an intersecting direction that intersects a longitudinal direction of the moving body. The longitudinal direction is a direction of travel of the moving body. The recessed groove is provided at a position between the ridges. Each of the ridges has a width decreasing toward a protruding end. The recessed groove has a width decreasing toward a bottom. A distance between the ridges is determined in accordance with a wall friction coefficient between the outer surface and a fluid flowing along the outer surface. The wall friction coefficient is a wall friction coefficient in the vicinity of the flow separation suppressing portion on the outer surface.

### CROSS-REFERENCE TO RELATED APPLICATIONS

This application is based upon and claims the benefit of priority from Japanese Patent Application No. 2024-229827, filed on Dec. 26, 2024, the entire contents of which are incorporated herein by reference.

### BACKGROUND

### 1. Field

The present disclosure relates to a flow separation suppression device.

### 2. Description of Related Art

JP2004-345562A discloses a flow separation suppression device that includes multiple projections. The projections are significantly smaller than the thickness of a boundary layer of an airflow. When the device is employed in a vehicle, the projections are arranged in the vehicle width direction along a rear end portion of the roof, while being spaced apart from each other.

In such a device, the projections control the flow of air (airflow) along the outer surface of the vehicle during traveling. The device thus suppresses flow separation of the airflow near the rear end portion of the roof, more specifically, in the vicinity of the rear window, thereby reducing aerodynamic drag acting on the vehicle.

However, the state of airflow over various regions of the vehicle outer surface is not uniform. Accordingly, merely providing projections on the vehicle outer surface does not necessarily ensure proper control of the airflow in regions where such projections are disposed. The flow separation suppression device disclosed in the above publication therefore leaves room for improvement in this respect.

The foregoing issues relating to airflow control by projections are not limited to vehicles, but are generally common to other moving bodies such as ships and aircraft, on which similar projections may also be provided.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a flow separation suppression device is provided on an outer surface of a moving body and suppresses separation of a flow of a fluid along the outer surface. The flow separation suppression device includes a flow separation suppressing portion. The flow separation suppressing portion includes two ridges and a recessed groove. The two ridges are spaced apart from each other in an intersecting direction that intersects a longitudinal direction of the moving body. The longitudinal direction is a direction of travel of the moving body. The recessed groove is provided at a position between the ridges. Each of the ridges protrudes from the outer surface, has a width decreasing toward a protruding end, and extends in the longitudinal direction. The recessed groove is recessed from the outer surface, has a width decreasing toward a bottom, and extends in the longitudinal direction. A distance between the ridges is determined in accordance with a wall friction coefficient between the outer surface and a fluid flowing along the outer surface, the wall friction coefficient being a wall friction coefficient in a vicinity of the flow separation suppressing portion on the outer surface.

Other features and aspects will be apparent from the following detailed description, the drawings, and the claims.

### BRIEF DESCRIPTION OF THE DRAWINGS

FIG. 1 is a side view of a vehicle equipped with a flow separation suppression device according to an embodiment.

FIG. 2 is a side view showing a rear spoiler of the vehicle and its periphery.

FIG. 3 is a plan view of the rear spoiler of the vehicle.

FIG. 4 is a perspective view of the flow separation suppression device of the embodiment as viewed obliquely from above.

FIG. 5 is a rear view of the upper surface of flow separation suppressing portions of the embodiment.

FIG. 6 is a rear view of the upper surface of flow separation suppressing portions of the embodiment.

FIG. 7 is a left side view of the upper surface of a flow separation suppressing portion of the embodiment.

FIG. 8 is a left side view of the upper surface of a flow separation suppressing portion of the embodiment.

FIG. 9 is a rear view of the upper surface of multiple flow separation suppressing portions.

FIG. 10 is an image showing results of a simulation conducted by the inventors.

FIG. 11 is an explanatory diagram showing operation of the flow separation suppression device of the embodiment.

FIG. 12 is a rear view of the upper surface of flow separation suppressing portions according to a modification.

FIG. 13 is a rear view of the upper surface of flow separation suppressing portions according to another modification.

FIG. 14 is a rear view of the upper surface of flow separation suppressing portions according to yet another modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

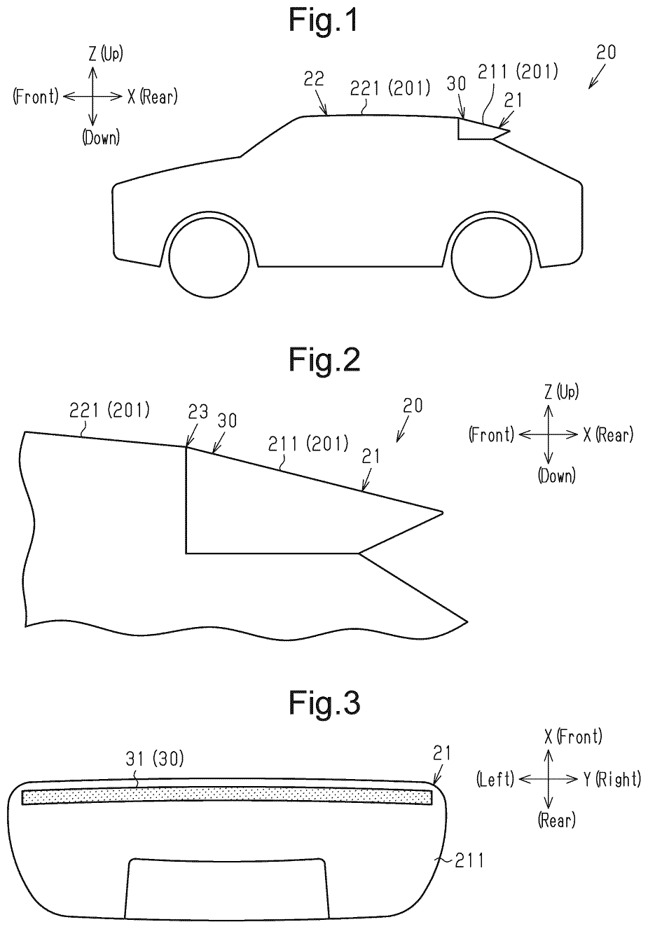

A flow separation suppression device 30 according to an embodiment is described below with reference to FIGS. 1 to 11.

As shown in FIG. 1, the flow separation suppression device 30 is employed in a vehicle 20 such as an automobile. In the following description, the longitudinal direction of the vehicle 20 during travel (specifically, during straight-ahead travel) is defined as a longitudinal direction X; the vehicle width direction is defined as a vehicle width direction Y; and the vertical direction of the vehicle 20 when the vehicle 20 is positioned on a horizontal plane is defined as a vertical direction Z. In addition, the front and rear in the longitudinal direction X is respectively referred to simply as the front side and rear side; the right and left in the vehicle width direction Y is respectively referred to simply as the right side and left side; and the upper and lower in the vertical direction Z is respectively referred to simply as the upper side and lower side.

The vehicle 20 includes a rear spoiler 21. The rear spoiler 21 is attached to a rear portion of the vehicle 20, more specifically, a rear portion of a roof 22. An upper surface of the rear spoiler 21 (hereinafter referred to as a spoiler upper surface 211) forms a part of an upper surface of the vehicle 20 (hereinafter referred to as a vehicle upper surface 201).

As shown in FIG. 2, in the vehicle 20, a rear end portion of an upper surface of the roof 22 (hereinafter referred to as a roof upper surface 221) and a front end portion of the spoiler upper surface 211 are inclined so as to be lowered toward the rear side. In a portion corresponding to a boundary between the rear end portion of the roof 22 and the front end portion of the rear spoiler 21 (hereinafter, referred to as a boundary portion 23), the curvature of the vehicle upper surface 201 is larger than those of portions forward of and rearward of the boundary portion 23. Specifically, the vehicle upper surface 201 is curved to bulge upward at the boundary portion 23. Due to such a shape of the vehicle upper surface 201, when the vehicle 20 travels forward, the pressure gradient becomes positive in the region on the vehicle upper surface 201 rearward of the boundary portion 23. The rearward region includes the front end portion of the spoiler upper surface 211. Further, due to the above-described shape, the positive pressure gradient increases toward the rear of the vehicle 20 in a section of the rearward region that is adjacent to the boundary portion 23, that is, in the front end portion of the spoiler upper surface 211.

As shown in FIGS. 1 to 3, the flow separation suppression device 30 of the present embodiment is provided at the front end portion of the spoiler upper surface 211. Specifically, the flow separation suppression device 30 is provided such that the front end of the flow separation suppression device 30 is positioned rearward of the front end of the spoiler upper surface 211. In other words, the flow separation suppression device 30 is disposed in a section of the outer surface of the vehicle 20 that has a positive pressure gradient, and in this section, the positive pressure gradient increases toward the rear of the vehicle 20.

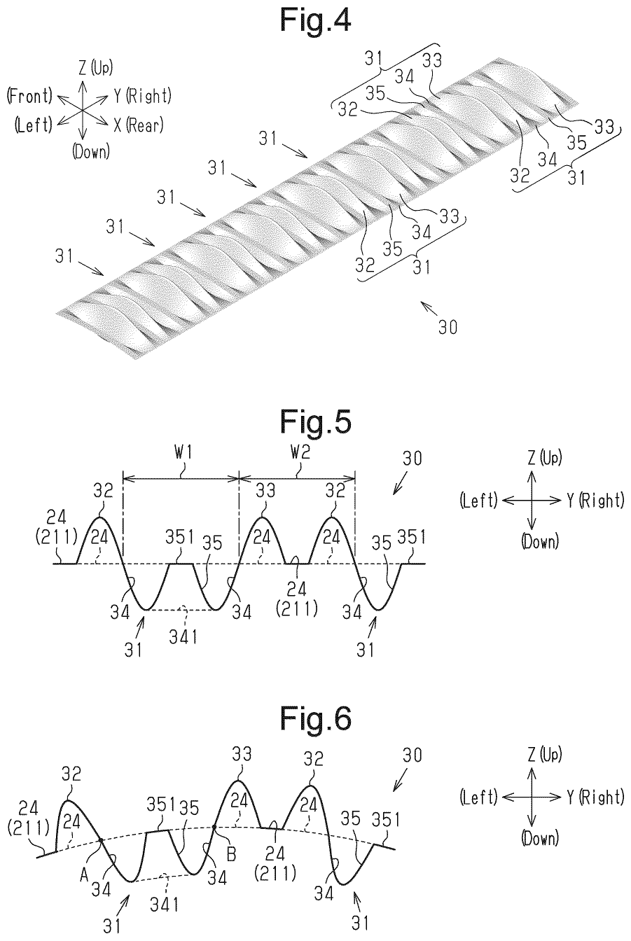

As shown in FIGS. 4 to 8, the flow separation suppression device 30 includes multiple flow separation suppressing portions 31. The flow separation suppressing portions 31 are arranged in a single row at intervals in an intersecting direction (in the present embodiment, the vehicle width direction Y), which intersects the longitudinal direction X. In the present embodiment, the flow separation suppressing portions 31 are provided at the front end portion of the spoiler upper surface 211. Specifically, the flow separation suppressing portions 31 are formed integrally with the rear spoiler 21 so as to form a part of the upper wall of the rear spoiler 21. The flow separation suppression device 30 suppresses separation of the airflow flowing along the spoiler upper surface 211.

### Flow Separation Suppressing Portions 31

The basic structure of the flow separation suppressing portions 31 is described below.

As shown in FIGS. 4 to 6, each flow separation suppressing portion 31 includes two ridges 32, 33, one recessed groove 34, and one projection 35.

### Two Ridges 32, 33

The two ridges 32, 33 include a first ridge 32 disposed on the left side and a second ridge 33 disposed on the right side. The first ridge 32 and the second ridge 33 have the same outer surface shape. The first ridge 32 and the second ridge 33 are arranged with a distance W1 therebetween in the intersecting direction (the vehicle width direction Y in the present embodiment), which intersect the longitudinal direction X.

As shown in FIGS. 4 through 8, the ridges 32, 33 protrude from the spoiler upper surface 211. The ridges 32, 33 are protrusions extending in the longitudinal direction X. The outer surface shape of each of the ridges 32, 33 has a width decreasing toward the protruding end. Specifically, the width of the outer surface shape of each of the ridges 32, 33 increases from the front end to the center in the longitudinal direction X, is maximized at the center in the longitudinal direction X, and then decreases from the center in the longitudinal direction X toward the rear end. FIGS. 5 through 8 show cross-sectional shape of the outer surface of the flow separation suppressing portions 31 at the center in the longitudinal direction X.

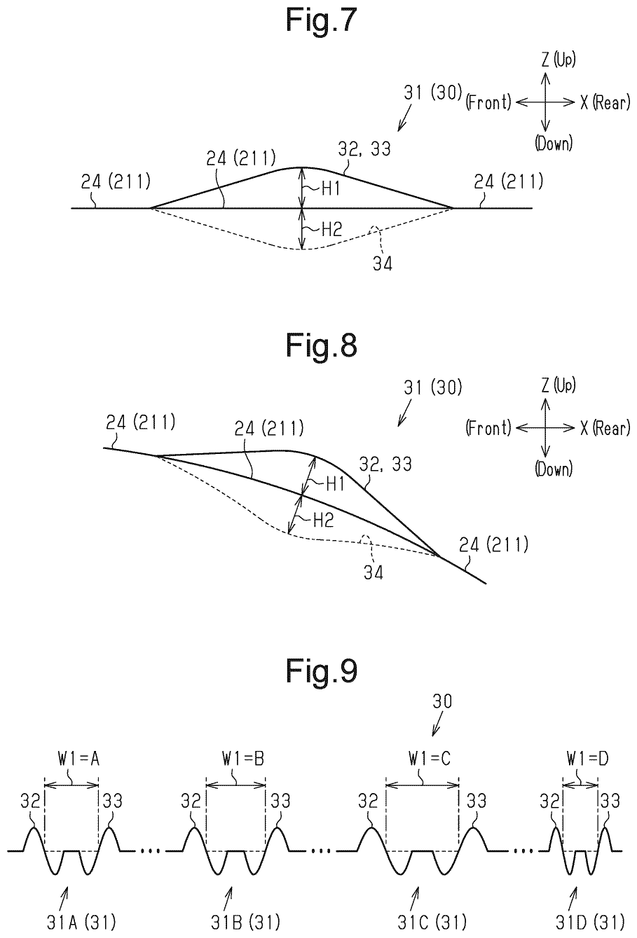

As shown in FIGS. 7 and 8, a protruding height H1 of the ridges 32, 33 from a reference surface 24 increases from the front end toward the center in the longitudinal direction X, and decreases from the center in the longitudinal direction X toward the rear end. The protruding height H1 is maximized at the center of the ridges 32, 33 in the longitudinal direction X. The reference surface 24 refers to a surface that would form the outer surface of the rear spoiler 21 in a hypothetical state in which the flow separation suppressing portions 31 are not provided.

### Recessed Grooves 34

As shown in FIGS. 4 through 6, each recessed groove 34 is provided at a position between the corresponding ridges 32 and 33 in the vehicle width direction Y.

As shown in FIGS. 4 through 8, each recessed groove 34 is recessed from the spoiler upper surface 211. The recessed groove 34 extends in the longitudinal direction X. The recessed groove 34 has a width that decreases toward a bottom 341. The width of the inner surface shape of the recessed groove 34 decreases from the front end to the center in the longitudinal direction X, is minimized at the center in the longitudinal direction X, and then increases from the center in the longitudinal direction X toward the rear end.

As shown in FIGS. 7 and 8, a depth H2 of each recessed groove 34 from the reference surface 24 increases from the front end of the recessed groove 34 toward the center in the longitudinal direction X, and decreases from the center in the longitudinal direction X toward the rear end. The depth H2 is maximized at the center in the longitudinal direction X of the recessed groove 34.

### Projections 35

As shown in FIGS. 4 through 6, a projection 35 is provided on the bottom 341 of each recessed groove 34. The projection 35 protrudes from the bottom 341 of the recessed groove 34. The projection 35 extends in the longitudinal direction X at the center in the width direction of the recessed groove 34. The outer surface shape of the projection 35 has a width decreasing toward the tip. An upper surface of the projection 35 (hereinafter referred to as a projection upper surface 351) extends on the same plane as the reference surface 24 in the longitudinal direction X and has a uniform width. The distance between the opposite side surfaces of the projection 35 decreases from the front end toward the center in the longitudinal direction X, is minimized at the center in the longitudinal direction X, and increases from the center in the longitudinal direction X toward the rear end. The protruding height of the projection 35 from the bottom 341 of the recessed groove 34 is equal to the depth H2 of the recessed groove 34 from the reference surface 24 (see FIGS. 7 and 8). Accordingly, the protruding height of the projection 35 from the bottom 341 of the recessed groove 34 increases from the front end of the projection 35 toward the center in the longitudinal direction X, and decreases from the center in the longitudinal direction X toward the rear end. The height of the projection 35 is maximized at the center in the longitudinal direction X.

In the present embodiment, each flow separation suppressing portion 31 includes two ridges 32, 33, one recessed groove 34, and one projection 35. FIGS. 5 and 7 show the outer surface shape of a flow separation suppressing portion 31 in a region where the reference surface 24 is flat. FIGS. 6 and 8 show the outer surface shape of a flow separation suppressing portion 31 in a region where the reference surface 24 is arcuate. In the present embodiment, as shown in FIGS. 6 and 8, in a region where the reference surface 24 is not flat, the two ridges 32, 33, the recessed groove 34, and the projection 35, which form a flow separation suppressing portion 31, are provided to extend along the reference surface 24.

As shown in FIGS. 5 and 6, in the present embodiment, a continuous surface formed by connecting the right-side outer surface of the first ridge 32, the left-side inner surface of the recessed groove 34, and the left-side outer surface of the projection 35 is a smooth surface, such as one having a sinusoidal cross-sectional profile, without any step at the junctions. Likewise, a continuous surface formed by connecting the left-side outer surface of the second ridge 33, the right-side inner surface of the recessed groove 34, and the right-side outer surface of the projection 35 is a smooth surface, such as one having a sinusoidal cross-sectional profile, without any step at the junctions.

In the present embodiment, in order to reliably suppress separation of the airflow along the spoiler upper surface 211, the distance W1 (FIG. 5) between the two ridges 32 and 33 in each flow separation suppressing portion 31 is determined in accordance with a wall friction coefficient Cf between the vehicle upper surface 201 and the air flowing along the vehicle upper surface 201. In the present embodiment, when the distance W1 is determined in this manner, the wall friction coefficient in the vicinity of each flow separation suppressing portion 31 on the vehicle upper surface 201 is used as the wall friction coefficient Cf. Specifically, the wall friction coefficient Cf is a wall friction coefficient of a region forward of the flow separation suppressing portions 31 (specifically, the front end of the spoiler upper surface 211), that is, a portion disposed forward of the flow separation suppressing portions 31.

In the present embodiment, the distance W1 is a length measured along the reference surface 24. For example, in the example shown in FIG. 6, the distance W1 corresponds to the length of a line along the reference surface 24 from point A to point B on the reference surface 24.

In the present embodiment, the structure for setting the distance W1 in accordance with the wall friction coefficient Cf is individually implemented for each of the flow separation suppressing portions 31, which form the flow separation suppression device 30. Accordingly, in the present embodiment, as shown in FIG. 9, the distance W1 varies among the multiple flow separation suppressing portions 31. In the present embodiment, the multiple flow separation suppressing portions 31 include four types having different distances W1. Specifically, the flow separation suppressing portions 31 include a flow separation suppressing portion 31A having a distance W1 of a value A, a flow separation suppressing portion 31B having a distance W1 of a value B, a flow separation suppressing portion 31C having a distance W1 of a value C, and a flow separation suppressing portion 31D having a distance W1 of a value D.

In the present embodiment, the flow separation suppressing portions 31 are provided on the spoiler upper surface 211 in order to generate a streak structure on the spoiler upper surface 211. When a streak structure is formed, high speed regions, in which the airflow velocity is relatively high, and low speed regions, in which the airflow velocity is relatively low, are arranged alternately in the vehicle width direction Y on the spoiler upper surface 211. In this case, a period λy, which corresponds to a set of regions including one high speed region and one adjacent low speed region, varies in accordance with the wall friction coefficient Cf of the spoiler upper surface 211.

The inventors of the present application have found the following. If the period λy and the distance W1 agree with each other, the flow separation suppressing portions 31 generate a streak structure on the spoiler upper surface 211 in a manner suitable for suppressing the separation of airflow.

In the present embodiment, the period λy is obtained based on the wall friction coefficient Cf, and the distance W1 between a pair of the ridges 32 and 33 is set to the period λy. As a result, a streak structure is generated in each region on the spoiler upper surface 211, that is, in each region in which a flow separation suppressing portion 31 is provided, in a manner suitable for suppressing separation of airflow.

The wall friction coefficient Cf in each region of the front end of the spoiler upper surface 211 can be obtained, for example, based on results of a simulation. In the present embodiment, the wall friction coefficient Cf in each region is obtained based on the result of a simulation (specifically, fluid analysis using computational fluid dynamics (CFD)) by the inventors.

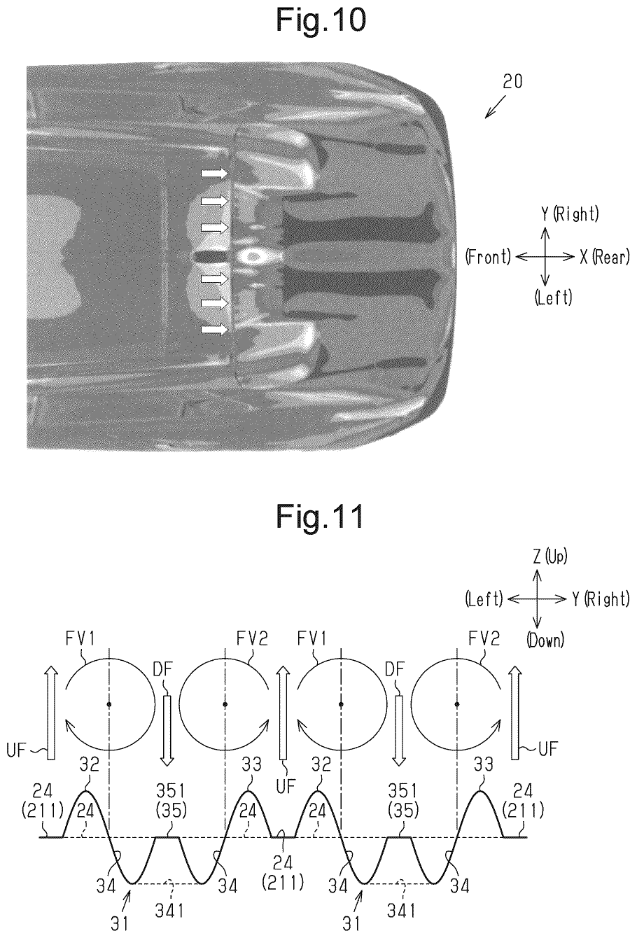

FIG. 10 shows results of a simulation conducted by the inventors. As a result of the simulation, a color image was obtained that indicates, by the displayed color and its shading intensity, the magnitude of the wall friction coefficient Cf at various regions on the vehicle upper surface 201 including the spoiler upper surface 211. FIG. 10 illustrates this color image after conversion into a grayscale image. As is apparent in FIG. 10, the wall friction coefficient Cf exhibits a distribution at the front end of the spoiler upper surface 211 (the portion indicated by the blank arrows in FIG. 10). In the present embodiment, the distance W1 between the ridges 32 and 33 in each flow separation suppressing portion 31 is set in accordance with the wall friction coefficient Cf.

The distance W1 between the ridges 32 and 33 is calculated as follows. The period λy is determined based on the wall friction coefficient Cf corresponding to the region on the spoiler upper surface 211 where each flow separation suppressing portion 31 is to be disposed, together with an air density p, an airflow velocity U, and a coefficient of kinematic viscosity v of air. The distance W1 can be set to the determined period λy.

Specifically, the period λy can be determined using the following relational expressions (1) through (3) based on, for example, the wall friction coefficient Cf, the air density ρ, the airflow velocity U, and the kinematic viscosity v of air.

$$( Cf ) = ( Tw ) / [ ( 1 / 2 ) \times ( ρ ) \times square of ( U ) ] \qquad ( 1 )$$

$$( Tw ) = ( ρ ) \times [ square of ( Ut ) ] \qquad ( 2 )$$

$$( λ y + ) = ( λ y ) \times ( Ut ) / ( v ) \qquad ( 3 )$$

In the relational expression (1), (Tw) represents a shear stress. In the relational expression (3), (λy+) represents a dimensionless number, and (Ut) represents a friction velocity. When the period λy is obtained by using the relational expressions (1) through (3), the dimensionless number λy+ is preferably set to 100.

### Operation and Advantages of the Present Embodiment

Operation and advantages of the present embodiment are described below.

As shown in FIG. 11, the left-side portion of the outer surface of each flow separation suppressing portion 31 is formed as a continuous surface formed by connecting the right-side outer surface of the first ridge 32, the left-side inner surface of the recessed groove 34, and the left-side outer surface of the projection 35. The right-side outer surface of the first ridge 32 and the left-side inner surface of the recessed groove 34 together define a surface sloping downward toward the right, and the left-side outer surface of the subsequent projection 35 defines a surface sloping upward toward the right.

The right-side portion of the outer surface of each flow separation suppressing portion 31 is formed as a continuous surface formed by connecting the left-side outer surface of the second ridge 33, the right-side inner surface of the recessed groove 34, and the right-side outer surface of the projection 35. The left-side outer surface of the second ridge 33 and the right-side inner surface of the recessed groove 34 together define a surface sloping downward toward the left, and the right-side outer surface of the subsequent projection 35 defines a surface sloping upward toward the left.

In the present embodiment, some of the air flowing along the spoiler upper surface 211 flows along the left-side portion of the outer surface of each flow separation suppressing portion 31 or flows along the right-side portion of the outer surface, so that an airflow including a component directed in the vertical direction Z is generated in the vicinity of the spoiler upper surface 211. Specifically, an airflow DF including a downward component is generated above a region corresponding to the center in the vehicle width direction Y of the flow separation suppressing portion 31. In addition, upward airflows UF are formed above regions of the flow separation suppressing portion 31 corresponding to the opposite sides in the vehicle width direction Y.

These airflows DF, UF induce two longitudinal vortices (a first vortex flow FV1 and a second vortex flow FV2). Specifically, the first vortex flow FV1, which rotates clockwise as viewed from the rear, is induced above the left side of the flow separation suppressing portion 31. Also, the second vortex flow FV2, which rotates counterclockwise as viewed from the rear, is induced above the right side of the flow separation suppressing portion 31.

As described above, each of the flow separation suppressing portions 31 generates two vortex flows FV1, FV2. The two vortex flows FV1, FV2 then generate turbulence. Moreover, since the two vortex flows FV1, FV2 swirl in opposite directions, the transition of the airflow along the spoiler upper surface 211 to a turbulent state is promoted more effectively than in a case in which only vortex flows swirling in the same direction are generated.

As a result, energy derived from the turbulence is supplied to the vicinity of the spoiler upper surface 211. This suppresses separation of the airflow along the spoiler upper surface 211. By suppressing airflow separation in this manner, the pressure drag on the vehicle upper surface 201 is reduced, thereby decreasing the aerodynamic drag acting on the vehicle 20.

Moreover, in the present embodiment, the distance W1 between the two ridges 32 and 33 in each flow separation suppressing portion 31 is determined in accordance with the wall friction coefficient Cf of the front end of the spoiler upper surface 211. This allows the distance W1 to be determined based on a coherent fluid structure that achieves maximum amplification according to fluid dynamic theory. Consequently, in the regions of the spoiler upper surface 211 where the flow separation suppressing portions 31 are provided, a streak structure is generated in a manner suitable for suppressing airflow separation. At this time, the first vortex flow FV1 and the second vortex flow FV2 are generated as vortex flows of sufficient strength to effectively suppress separation of the airflow.

In the present embodiment, the structure in which the distance W1 is determined in accordance with the wall friction coefficient Cf is individually implemented for each of the multiple flow separation suppressing portions 31. Consequently, in each region of the spoiler upper surface 211, specifically, in each of the regions where the flow separation suppressing portions 31 are provided, a streak structure is generated in a manner suitable for suppressing airflow separation. Accordingly, the separation of the airflow is suppressed over a wide range on the spoiler upper surface 211, so that the aerodynamic drag acting on the vehicle 20 is favorably reduced.

The advantages of the present embodiment are described below.

(1) Since separation of the airflow flowing along the spoiler upper surface 211 is suppressed, the pressure drag on the vehicle upper surface 201 is reduced. In addition, since a streak structure is generated on the spoiler upper surface 211 in a manner suitable for suppressing separation of the airflow, the pressure drag on the spoiler upper surface 211 is favorably reduced. Therefore, the aerodynamic drag acting on the vehicle 20 is favorably reduced.

(2) The flow separation suppressing portions 31 are provided so as to be arranged in the vehicle width direction Y. The structure in which the distance W1 between the ridges 32 and 33 is set in accordance with the wall friction coefficient Cf is individually implemented for each of the flow separation suppressing portions 31. Accordingly, separation of an airflow is reliably suppressed over a wide range on the spoiler upper surface 211, so that the pressure drag on the spoiler upper surface 211 is favorably reduced.

(3) The distance W1 is a length measured along the reference surface 24, which would form the spoiler upper surface 211 in a hypothetical state in which the flow separation suppressing portions 31 are not provided.

According to this configuration, the distance W1 between the ridges 32 and 33 is defined in conformity with the shape of the spoiler upper surface 211 (specifically, the reference surface 24) so that airflow separation is reliably suppressed.

(4) The bottom 341 of each recessed groove 34 is provided with a projection 35, which protrudes from the bottom surface of the recessed groove 34, has a width decreasing toward the protruding end, and extends in the longitudinal direction X.

According to this configuration, the first vortex flow FV1 is generated by a continuous surface formed by connecting the right-side outer surface of the first ridge 32, the left-side inner surface of the recessed groove 34, and the left-side outer surface of the projection 35. Also, the second vortex flow FV2 is generated by a continuous surface formed by connecting the left-side outer surface of the second ridge 33, the right-side inner surface of the recessed groove 34, and the right-side outer surface of the projection 35. Thus, in each flow separation suppressing portion 31, the section for generating the first vortex flow FV1 and the section for generating the second vortex flow FV2 are separated from each other by the projection 35. Accordingly, the first vortex flow FV1 and the second vortex flow FV2 can each be generated with high accuracy in a desired manner.

(5) The flow separation suppression device 30 is disposed in a section of the outer surface of the vehicle 20 that has a positive pressure gradient, and in this section, the positive pressure gradient increases toward the rear of the vehicle 20.

According to this configuration, the flow separation suppressing portions 31 are provided in regions on the vehicle upper surface 201 forward of regions where airflow separation is likely to occur. Therefore, the flow separation suppressing portions 31 reliably suppress the occurrence of airflow separation in regions rearward of the flow separation suppressing portions 31.

(6) The flow separation suppressing portions 31 are provided on the spoiler upper surface 211. Consequently, separation of the airflow along the vehicle upper surface 201, including the spoiler upper surface 211, is suppressed. Accordingly, the aerodynamic drag acting on the vehicle 20 during traveling is reduced.

### Modifications

The above-described embodiment may be modified as follows. The above-described embodiment and the following modifications can be combined as long as the combined modifications remain technically consistent with each other.

The distance W1 between the ridges 32 and 33 can be changed as long as it is a value (distance) corresponding to the wall friction coefficient Cf. The distance W1 may be set to, for example, a value slightly different from the period λy, or a value obtained by doubling the period λy ([λy]×2). That is, the distance W1 may be set to a value that generates a streak structure on the spoiler upper surface 211 in a manner suitable for suppressing separation of the airflow.

Only a single flow separation suppressing portion 31 may be provided. In other words, the flow separation suppression device 30 may include only one flow separation suppressing portion 31.

The projection upper surface 351 may be a surface extending on the same plane as the reference surface 24, a surface extending below the reference surface 24, or a surface extending above the reference surface 24.

The distance between two adjacent flow separation suppressing portions 31 (for example, the distance indicated by W2 in FIG. 5) may be determined in accordance with the wall friction coefficient Cf, similarly to the distance W1 between the ridges 32 and 33. In this case, the wall friction coefficient Cf is preferably a wall friction coefficient in the vicinity of a region on the vehicle upper surface 201 between two adjacent flow separation suppressing portions 31. Specifically, the wall friction coefficient Cf may be a wall friction coefficient in a region forward of or rearward of the region between the two flow separation suppressing portions 31.

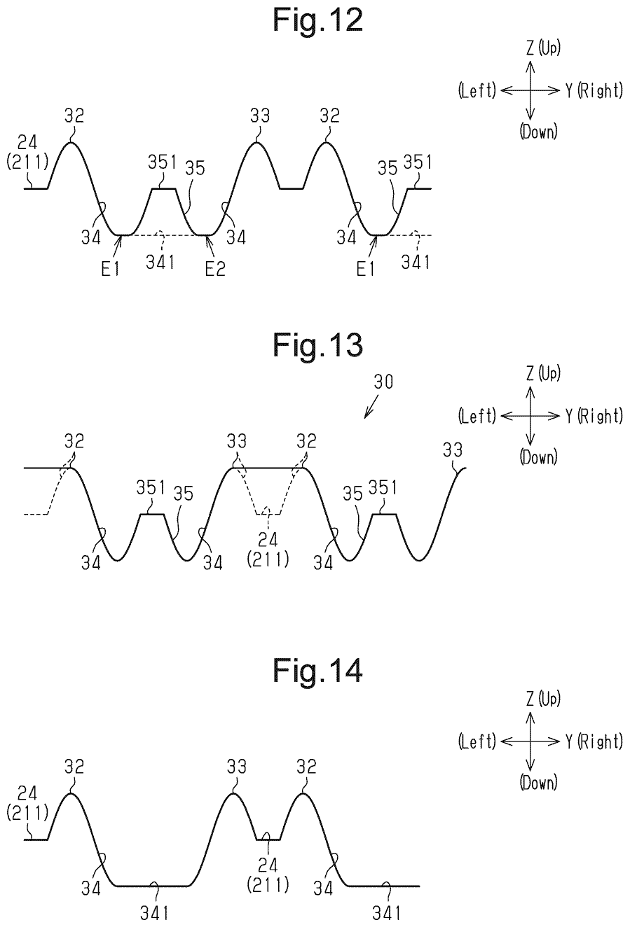

As shown in FIG. 12, part of the bottom surface of each recessed groove 34 (for example, portions indicated by arrows E1, E2 in FIG. 12) may be formed by a surface extending linearly in the vehicle width direction Y.

The first ridge 32 of one of two adjacent flow separation suppressing portions 31 and the second ridge 33 of the other flow separation suppressing portion 31 may be integrally formed as shown in FIG. 13, instead of being spaced apart from each other in the vehicle width direction Y. In the example shown in FIG. 13, the outer surface shape of the first ridge 32 and the second ridge 33 is a shape in which the protruding end of the first ridge 32 and the protruding end of the second ridge 33 are connected by a surface extending linearly in the vehicle width direction Y.

As shown in FIG. 14, the projection 35 (see FIG. 5) may be omitted. Even in such a configuration, two vortex flows FV1, FV2, which swirl in different directions, are induced by a single flow separation suppressing portion 31. Specifically, the first vortex flow FV1 is generated by a surface sloping downward toward the right formed by the right-side outer surface of the first ridge 32 and the left-side inner surface of the recessed groove 34. Also, the second vortex flow FV2 is generated by a surface sloping downward toward the left formed by the left-side outer surface of the second ridge 33 and the right-side inner surface of the recessed groove 34.

The flow separation suppression device 30 is not limited to being disposed in a region on the vehicle upper surface 201 that has a positive pressure gradient and in which the positive pressure gradient increases toward the rear of the vehicle 20 (hereinafter referred to as a positive region), and may be disposed in any region on the vehicle upper surface 201. For example, the flow separation suppression device 30 may be provided at a position that includes a region on the vehicle upper surface 201 that is forward of the above-described positive region, or may be provided at a position that includes a region on the vehicle upper surface 201 that is rearward of the above-described positive region. Alternatively, the flow separation suppression device 30 may be provided at a position on the vehicle upper surface 201 that is forward of the above-described positive region, or may be provided at a position on the vehicle upper surface 201 that is rearward of the above-described positive region.

The wall friction coefficient Cf, which is used to determine the distance W1 between the ridges 32 and 33, can be changed as long as the wall friction coefficient Cfis a wall friction coefficient in the vicinity of the flow separation suppressing portions 31 on the vehicle upper surface 201. For example, in the region on the vehicle upper surface 201 that is forward of the flow separation suppressing portions 31, the wall friction coefficient of the region rearward of the front end of the spoiler upper surface 211 may be used. Alternatively, the wall friction coefficient of the region forward of the front end of the spoiler upper surface 211 (a rear end portion of the roof 22) may be used. It is also possible to use the wall friction coefficient of a region on the spoiler upper surface 211 rearward of the flow separation suppressing portions 31, that is, a region disposed rearward of the flow separation suppressing portions 31.

Instead of integrally forming the flow separation suppression device 30 with the rear spoiler 21 so as to form part of the upper wall of the rear spoiler 21, the rear spoiler 21 including a flow separation suppression device 30 may be formed by fixing a separately formed flow separation suppression device 30 to the main body of the rear spoiler 21.

The flow separation suppression device 30 is not limited to being provided on the spoiler upper surface 211, and may be provided at any position on the outer surface of the vehicle 20, such as on the upper surface of the engine hood of the vehicle 20 or on the outer side surface of the vehicle 20. In the case in which the flow separation suppression device 30 is provided on the outer side surface of the vehicle 20, the direction in which the ridges 32, 33 are arranged with a space therebetween may be the vertical direction Z. In this configuration, the vertical direction Z corresponds to the intersecting direction, which intersects with the longitudinal direction X (the direction of travel of the vehicle 20).

The flow separation suppression device 30 according to the above-described embodiment is applicable not only to moving bodies that travel over land (such as automobiles and automatic guided vehicles) but also to moving bodies that travel through the air (such as aircraft and drones) as well as to moving bodies that travel on or under water (such as ships and submarines). In addition, the flow separation suppression device 30 according to the above-described embodiment can also be applied to a moving body (a turbine, a fan, or the like) that rotationally moves. In these configurations, the fluid flowing along the outer surface of the moving body includes a gas such as air, steam, or gas fuel, and a liquid such as water.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A flow separation suppression device that is provided on an outer surface of a moving body and suppresses separation of a flow of a fluid along the outer surface, the flow separation suppression device comprising a flow separation suppressing portion, the flow separation suppressing portion including:
two ridges spaced apart from each other in an intersecting direction that intersects a longitudinal direction of the moving body, the longitudinal direction being a direction of travel of the moving body; and
a recessed groove provided at a position between the ridges, wherein
each of the ridges protrudes from the outer surface, has a width decreasing toward a protruding end, and extends in the longitudinal direction,
the recessed groove is recessed from the outer surface, has a width decreasing toward a bottom, and extends in the longitudinal direction, and
a distance between the ridges is determined in accordance with a wall friction coefficient between the outer surface and a fluid flowing along the outer surface, the wall friction coefficient being a wall friction coefficient in a vicinity of the flow separation suppressing portion on the outer surface.

2. The flow separation suppression device according to claim 1, wherein
the flow separation suppressing portion is one of multiple flow separation suppressing portions provided to be arranged in the intersecting direction, and
a structure in which the distance is determined in accordance with the wall friction coefficient is individually implemented for each of the flow separation suppressing portions.

3. The flow separation suppression device according to claim 1, wherein
a surface that would form the outer surface in a hypothetical state in which the flow separation suppressing portion is not provided is defined as a reference surface,
the distance is a length measured along the reference surface.

4. The flow separation suppression device according to claim 1, wherein the bottom of the recessed groove is provided with a projection that protrudes from a bottom surface of the recessed groove, has a width decreasing toward a protruding end thereof, and extends in the longitudinal direction.

5. The flow separation suppression device according to claim 1, wherein the flow separation suppressing portion is disposed in a region on the outer surface that has a positive pressure gradient increasing toward a rear in the longitudinal direction.

6. The flow separation suppression device according to claim 1, wherein
the moving body is a vehicle having a rear spoiler,
the fluid is air, and
the flow separation suppressing portion is provided on an upper surface of the rear spoiler.
